(19) United States
(12) Patent Application Publication
(10) Pub. No.: US 2007/0195206 A1
(43) Pub. Date: Aug. 23, 2007

(54) Projection display with front and back jack panel access

(75) Inventors: Scott Joseph Duggan, Indianapolis, IN (US); Darin Bradley Ritter, Indianapolis, IN (US); Lawrence Charles Coan, Indianapolis, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: Thomas Licensing, F-92100 Boulogne-Billancourt (FR)

(21) Appl. No.: 10/593,883

(22) PCT Filed: Mar. 21, 2005
(86) PCT No.: PCT/US05/09242

§ 371 Date: Sep. 21, 2006

Related U.S. Application Data
(60) Provisional application No. 60/557,980, filed on Mar. 31, 2004.

(51) Int. Cl. H04N 9/31

(52) U.S. Cl. 348/744

(57) ABSTRACT

A projection display is provided having visible surfaces and concealed surfaces during normal operation. The projection display comprises a jack panel having one or more connectors for making electrical connections to the projection display, and the jack panel is accessible from at least one visible surface and at least one concealed surface.

### CROSS-REFERENCE TO RELATED APPLICATIONS

This application claims the benefit of U.S. Provisional Patent Application Ser. No. 60/557,980, entitled “Projection Display Allowing Customer Access to Jack Panel from the Front, Side and Back of Display” and filed Mar. 31, 2004, which is incorporated by reference herein in its entirety.

### FIELD OF THE INVENTION

The invention relates generally to a projection display and, in particular a Jack Panel for a projection display screen.

### BACKGROUND OF THE INVENTION

Recent slim projection display televisions are designed to mount on a wall which makes access to the back difficult. It is desirable to have the cabling (antenna input, power cord, miscellaneous hook up cable) to and from the set, hidden from the viewer in normal operation.

Hiding the cables from the normal viewing positions can be difficult. Many displays that are designed to mount on a wall have jack panel access from one or more of the edges of the display. Visibility of the jacks during hook up is very limited without bumping your head on the wall. Some displays have very limited “Front Audio/Video Inputs” with no provisions for hiding the cables.

### SUMMARY OF THE INVENTION

A projection display is provided having visible surfaces and concealed surfaces during normal operation. The projection display comprises a jack panel having one or more connectors for making electrical connections to the projection display, and the jack panel is accessible from at least one visible surface and at least one concealed surface. With the jack panel being accessible from both a visible and a concealed surface, a “pass through” access is provided that allows a customer or user of the projection display to access the jack panel from a visible surface providing good visibility for making cable connections and to introduce cables through the opening in the concealed surface to provide an aesthetic appearance during normal operation (or viewing).

### BRIEF DESCRIPTION OF THE DRAWINGS

The invention will now be described by way of example with reference to the accompanying figures of which:

FIGS. 1A and 1B are perspective front views of a projection display according to an exemplary embodiment of the present invention, with FIG. 1A showing the display with a removable access panel in place and FIG. 1B showing the display with the removable access panel removed;

FIGS. 2A and 2B are perspective rear views of the projection display of FIGS. 1A and 1B, with FIG. 2A showing the display with a removable jack panel door in place and FIG. 2B showing the display with the removable jack panel door removed; and

FIG. 3 is a perspective front view of the projection display of FIGS. 1A-2B, showing the display with the removable access panel and the removable jack panel door removed.

### DETAILED DESCRIPTION

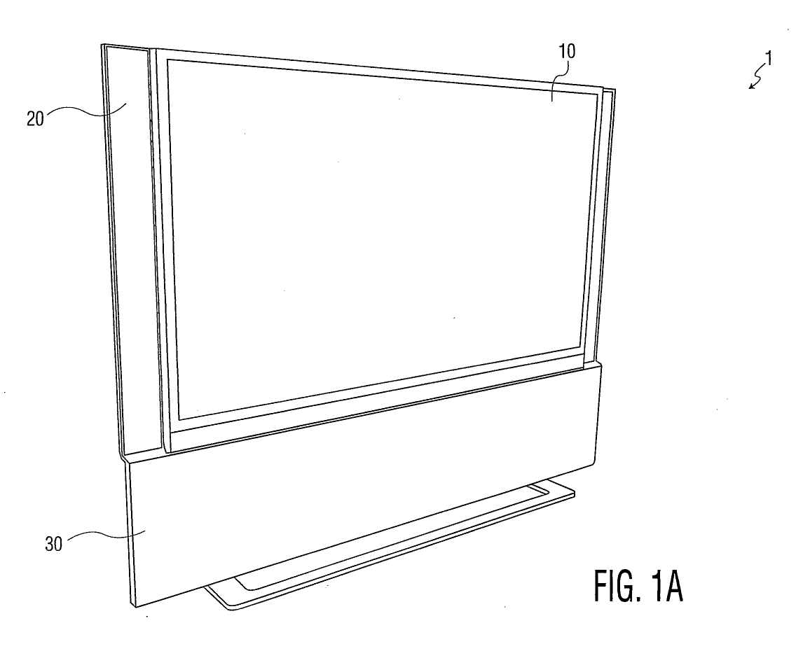

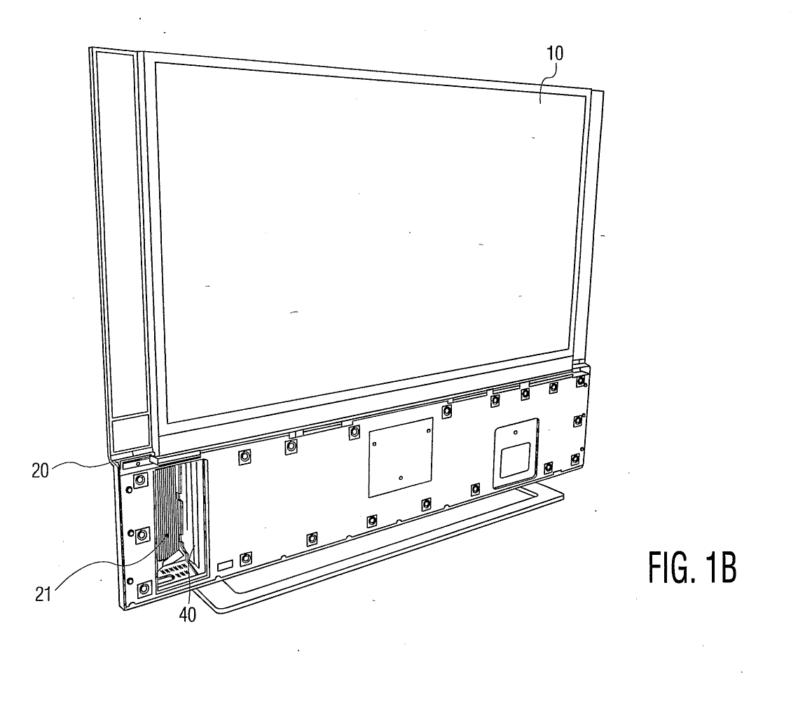

As shown in FIGS. 1A-3, the present invention allows a customer or user of an exemplary projection display 1 to remove a decorative access panel 30 from the front of the display, providing good visibility of the jack panel 40 (shown in FIG. 1B) and “pass through” cable access to the back of the display. The “pass through” jack panel access arrangement allows the owner or user to have access to the jack panel 40 from either of the front, side, or rear of the display.

The display 1 includes a screen 10 mounted to a frame 20. A jack panel 40 is used to make electrical connections with cables for providing power, signal, etc. to the display. An access opening 21 is provided in the front of the frame 20, below the screen 10. While the access opening 21 is provided below the screen 10 in the embodiment illustrated in FIGS. 1A, 1B, it should be understood that the access opening 21 could also be located on the side of the screen 10 or above the screen 10. An access panel 30 is removably attached to the frame 20 such that it covers the access opening 21. The access panel 30 may alternatively be a door or cover that opens via an opening mechanism such as, for example, a hinge. As previously mentioned, it is desirable to have cables located such that they are not visible to a user viewing the screen 10, and also to prove visible access to the jack panel 40. In the present embodiment, the access panel 30 provides visible access to the jack panel 40 from the front of the display.

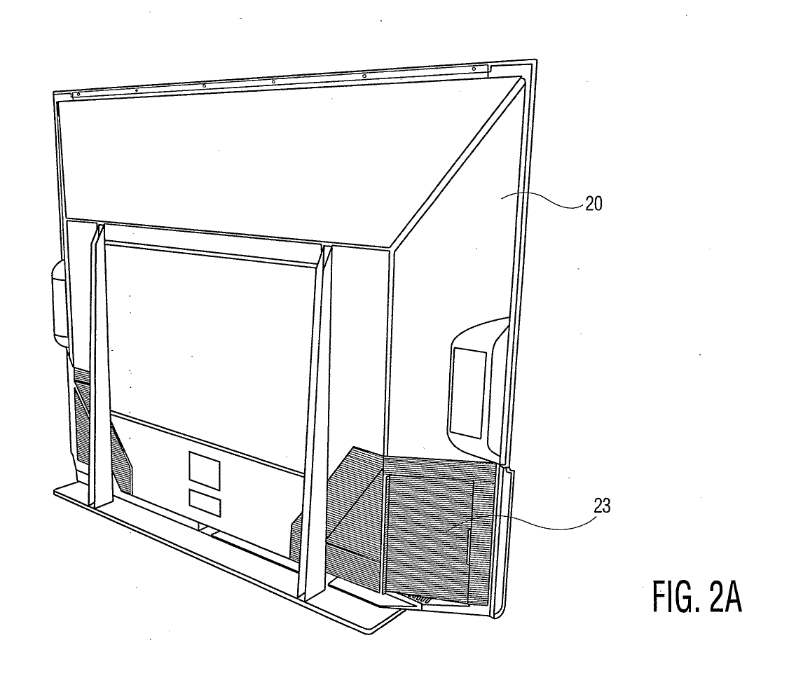

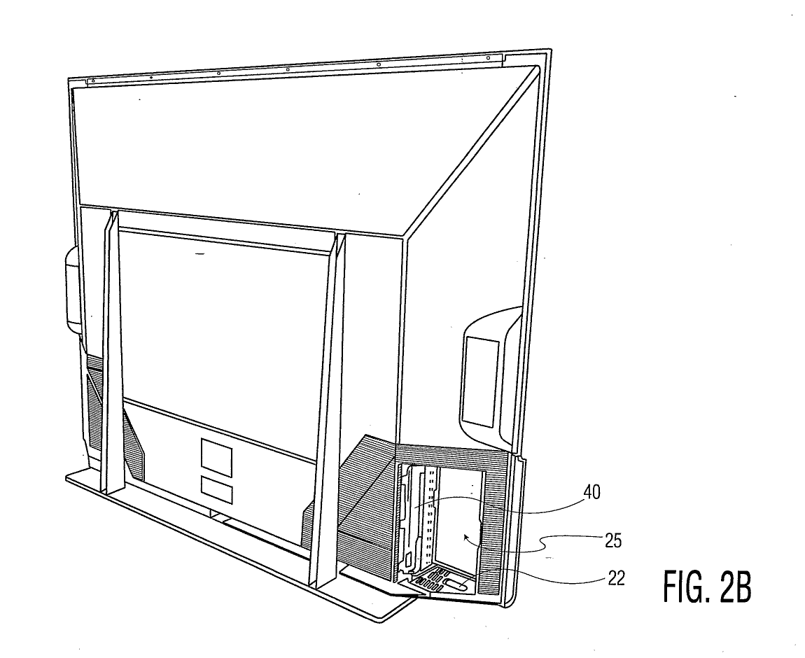

On the back or side of the frame 20, a jack panel opening 22 (shown in FIG. 2B) provides access to the jack panel 40. Cables (not shown) can be introduced through this jack panel opening 22 and connected to the jack panel 40 to provide power, signal, etc. to the display. A jack panel door 23 (shown in FIG. 2A) is removable attached to the frame 20 covering the jack panel opening 22.

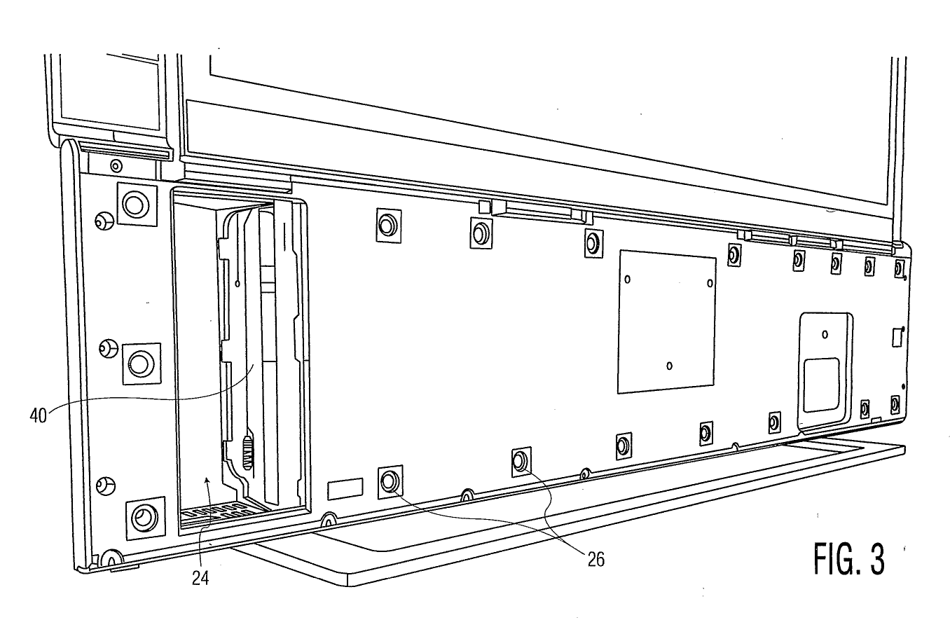

As shown in FIG. 3, with the access cover 30 and the jack panel door 23 removed, a jack panel cavity 24 is in communication with both the access opening 21 in a visible front surface of the frame 20 and the jack panel opening 22 in a concealed back or side surface of the frame 20. This permits “pass through” access to the jack panel 40, whereby easy visible access is provided for cable hook-ups to the display from the front of the display 1, and cables can be introduced from a concealed surface of the display. Thus, the “pass through” concept allows cables to be hooked up from the front of the display and passed through to the rear of the display.

Optionally, the frame 20 includes a hole 22 (shown in FIG. 2B) proximate the jack panel 40 that allows for easy hook-up of temporary cables like cameras and video games. Such an arrangement allows easy hook up of temporary and/or semi-permanent cables from the front of the set to any of the jacks on the jack panel 40. A decorative jack panel door 23 on the rear of the display may also provide aesthetic appeal.

Optionally, the access panel 30 may be attached to the frame with hidden attachment devices. For example, ball catches 26 may be provided in the frame to capture balls (not shown) on the access panel 30. Thus, the access panel 30 may be snapped in place on the frame 20 and provide an esthetic, appearance.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A projection display having visible surfaces and concealed surfaces during normal operation, the projection display comprising a jack panel having one or more connectors for making electrical connections to the projection display, the jack panel being accessible from at least one visible surface and at least one concealed surface.

2. The projection display of claim 1 wherein the jack panel is accessible from at least one visible surface through one of a removable access panel and an openable access panel.

3. The projection display of claim 1 wherein the projection display has a screen mounted in a frame, and the access panel is attached to the frame.

4. The projection display of claim 3 wherein the access panel is attached to the frame by ball catches.

5. The projection display of claim 3 wherein the access panel is attached to the frame below the screen.

6. The projection display of claim 1 wherein the jack panel is accessible from at least one concealed surface through a jack panel door.

7. The projection display of claim 6 wherein at least one electrical connector is introduced to the jack panel through the jack panel door.

8. A projection display, comprising:
a front surface with a display screen disposed thereon;
a housing supporting the display screen and forming a portion of the front surface, a back surface, and side surfaces;
a jack panel disposed in the housing and having one or more connectors for making electrical connections to the projection display;
a jack panel cavity adjacent the jack panel for receiving connectors for connection with the jack panel;
a connector opening in the back surface or one of the side surfaces in communication with the jack panel cavity for introducing the one or more connectors into the jack panel cavity;
an access opening in the front surface portion of the housing communicating with the jack panel cavity; and
an access panel attached to the front surface portion of the housing for covering the access opening.

9. The projection display of claim 8 wherein the access panel is attached to the frame by ball catches.

10. The projection display of claim 8 wherein the access panel is attached to the frame below the screen.

11. The projection display of claim 8 wherein at least one electrical connector is introduced to the jack panel through the connector opening.

12. The projection display of claim 11 wherein the connector opening is covered by a jack panel door.

13. The projection display of claim 8 wherein the jack panel is accessible from at least one visible surface through one of a removable access panel and an openable access panel.
